(19) United States
(12) Patent Application Publication
(10) Pub. No.: US 2020/0032985 A1
(43) Pub. Date: Jan. 30, 2020

(54) Easy-to-Assemble LED Bulb

(71) Applicant: Nanning City Hong Cai Illuminations Technology Company Limited, Nanning City (CN)

(72) Inventor: Faquan Liang, Nanning City (CN)

(73) Assignee: Nanning City Hong Cai Illuminations Technology Company Limited

(21) Appl. No.: 16/103,591

(22) Filed: Aug. 14, 2018

(30) Foreign Application Priority Data
Jul. 30, 2018 (CN) 201821216946.1

(51) Int. Cl. F21V 19/00; F21S 2/00; F21V 23/06; F21K 9/23

(52) U.S. Cl. CPC F21V 19/0025; F21S 2/005; F21Y 2115/10; F21V 19/003; F21K 9/23; F21V 23/06

(57) ABSTRACT

An easy-to-assemble LED bulb includes a bulb body, an LED lighting module, a stem, and a bulb holder. The bulb holder is coupled with the bulb body. The stem is partially inserted in the bulb body and cooperates with the bulb body to form a closed chamber. A positive lead and a negative lead are embedded in the stem. First ends of the positive lead and the negative lead are connected to a positive electrode and a negative electrode of the bulb holder, respectively. Second ends of the positive lead and the negative lead are connected to a positive electrode and a negative electrode of the LED lighting module, respectively. The LED light-emitting module has a gate-like shape and is formed by connecting an LED flip chip and a conductor support. The LED bulb has a simple structure to reduce the steps and the difficulty of the assembly.

### FIELD OF THE INVENTION

The present invention relates to an illumination device, and more particularly to an easy-to-assemble LED bulb.

### BACKGROUND OF THE INVENTION

As a green light source, LED has many advantages, including small size, low power consumption, long service life, high brightness, low heat, etc. Besides, in order to meet the needs of daily life, LED bulbs that combine LEDs with conventional bulbs are developed accordingly.

For the assembly of a conventional LED bulb, the assembly steps include: a conductor support and leads of a stem are soldered; an LED strip and the conductor support are soldered; and resistors are welded to a stem of the leads and a connecting section of a bulb holder. In the assembly process of such LED bulbs, there are disadvantages of more assembly steps and lower assembly efficiency. Further, one set of positive and negative electrodes on the conductor support needs to be properly soldered to the positive and negative electrodes on the LED strip. Another set of positive and negative electrodes on the conductor support needs to be properly soldered to the positive and negative leads on the stem. The components in the LED bulb include an LED strip, a conductor support and resistors which gradually become small in size. The clamping and welding in the production process are more and more inconvenient, which makes the assembly more troublesome. Therefore, there is a need for an LED bulb that is easy to assemble. Accordingly, the inventor of the present invention has devoted himself based on his many years of practical experiences to solve these problems.

### SUMMARY OF THE INVENTION

In view of the deficiencies of the prior art, the primary object of the present invention is to provide an easy-to-assemble LED bulb.

The present invention provides the following technical solutions:

An easy-to-assemble LED bulb comprises a bulb body, an LED lighting module, a stem, and a bulb holder. The bulb holder is coupled with the bulb body. The stem is partially inserted in the bulb body. The stem cooperates with the bulb body to form a closed chamber. A positive lead and a negative lead are embedded in the stem. First ends of the positive lead and the negative lead are connected to a positive electrode and a negative electrode of the bulb holder, respectively. Second ends of the positive lead and the negative lead are connected to a positive electrode and a negative electrode of the LED lighting module, respectively. The LED light-emitting module has a gate-like shape and is formed by connecting an LED flip chip and a conductor support.

Preferably, a plurality of resistors is packaged in the LED flip chip. The LED flip chip and the plurality of the resistors are connected in series.

Compared with the prior art, the present invention has the following beneficial effects:

The present invention has a simple structure. Through the modular structure of the LED light-emitting module and the resistors packaged in the LED flip chip, the assembly steps are reduced and the difficulty of assembly is reduced. Furthermore, the cost of industrial production is reduced, and the efficiency of industrial production is improved.

### BRIEF DESCRIPTION OF THE DRAWINGS

FIG. 1 is a structural schematic view of an easy-to-assemble LED bulb in accordance with an embodiment of the present invention.

### DETAILED DESCRIPTION OF THE PREFERRED EMBODIMENTS

Embodiments of the present invention will now be described, by way of example only, with reference to the accompanying drawings.

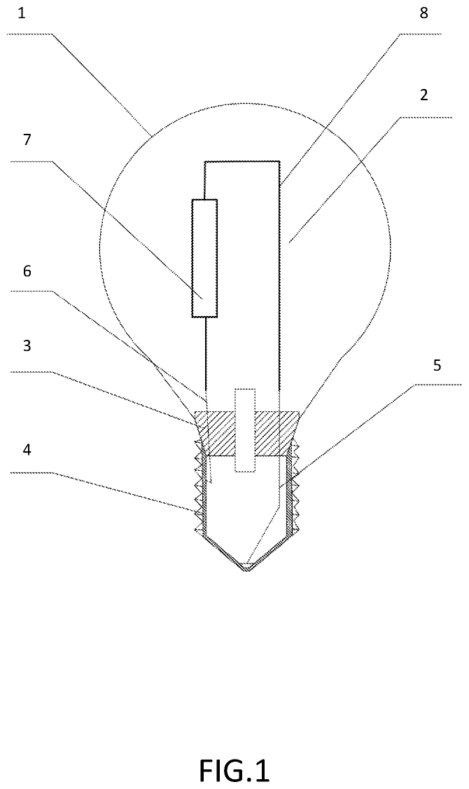

As shown in FIG. 1, an easy-to-assemble LED bulb in accordance with an embodiment of the present invention comprises a bulb body 1, an LED lighting module 2, a stem 3, and a bulb holder 4. The bulb holder 4 is coupled with the bulb body 1. After the stem 3 is partially inserted in the bulb body 1, the stem 3 cooperates with the bulb body 1 to form a closed chamber. A positive lead 5 and a negative lead 6 are embedded in the stem 3. First ends of the positive lead 5 and the negative lead 6 are connected to a positive electrode and a negative electrode of the bulb holder 4, respectively. Second ends of the positive lead 5 and the negative lead 6 are connected to a positive electrode and a negative electrode of the LED lighting module 2, respectively. When the bulb is powered on, the current drives the LED light emitting module 2 to emit light through the positive lead 5 and the negative lead 6. The LED light-emitting module 2 has a gate-like shape, which is formed by connecting an LED flip chip 7 and a conductor support 8 to realize the built-in and modularization of the LED light-emitting module 2, thereby reducing the assembly steps of the easy-to-assemble LED bulb. In addition, since the overall size of the LED lighting module 2 is increased, it is easier for clamping and welding, thereby reducing the difficulty of assembly. Furthermore, the cost of industrial production is reduced, and the efficiency of industrial production is improved.

A plurality of resistors is packaged in the LED flip chip 7. The LED flip chip 7 and the plurality of the resistors are connected in series. It can be known from the power calculation formula P=I²R of the bulb that the arrangement of the plurality of the resistors pre-installed in the LED flip chip 7 can effectively improve the power of the easy-to-assemble LED bulb, reduce the assembly steps and reduce the difficulty of assembly. Furthermore, the cost of industrial production is reduced, and the efficiency of industrial production is improved.

Specifically, the assembly process of the easy-to-assemble LED bulb is described below. The first ends of the positive lead 5 and the negative lead 6 are welded to the positive electrode and the negative electrode of the bulb holder 4, respectively. The stem 3 and the bulb body 1 are joined and sealed. The second ends of the positive lead 5 and the negative lead 6 are welded to the positive electrode and the negative electrode of the LED lighting module 2, respectively. The bulb holder 4 and the bulb body 1 are bonded with glue. The structure of the present invention is simpler and the assembly steps are less.

In summary, the present invention solves the deficiencies existing in the prior art through the above structural design and has the characteristics of simple structure, reasonable design, good use effect and the like.

Although particular embodiments of the present invention have been described in detail for purposes of illustration, various modifications and enhancements may be made without departing from the spirit and scope of the present invention. Accordingly, the present invention is not to be limited except as by the appended claims.

1. An LED bulb, comprising a bulb body (1), an LED lighting module (2), a stem (3) and a bulb holder (4); the bulb holder (4) being coupled with the bulb body (1); the stem (3) being partially inserted in the bulb body (1), the stem (3) cooperating with the bulb body (1) to form a closed chamber; a positive lead (5) and a negative lead (6) being embedded in the stem (3); first ends of the positive lead (5) and the negative lead (6) being connected to a positive electrode and a negative electrode of the bulb holder (4), respectively; second ends of the positive lead (5) and the negative lead (6) being connected to a positive electrode and a negative electrode of the LED lighting module (2), respectively; the LED light-emitting module (2) having a rectangular shape and being formed by connecting an LED flip chip (7) and a conductor support (8),
wherein the LED flip chip (7) is positioned off-center of the bulb body (1).

2. The LED bulb as claimed in claim 1, wherein a plurality of resistors is packaged in the LED flip chip (7); the LED flip chip (7) and the plurality of the resistors are connected in series.

3. A method for manufacturing the LED bulb of claim 1, comprising:
connecting the LED flip chip (7) and the conductor support (8) in a rectangular shape to the stem (3),
inserting the stem (3) into the bulb body (1),
welding the first end of the positive lead (5) to the positive electrode of the bulb holder (4),
welding the second end of the positive lead (5) to the positive electrode of the LED lighting module (2),
welding the first end of the negative lead (6) to the negative electrode of the bulb holder (4),
welding the second end of the negative lead (6) to the negative electrode of the LED lighting module (2),
joining and sealing the stem (3) and the bulb body (1), and
bonding the bulb body (1) to the bulb holder (4) via adhesive.
